(19) United States
(12) Patent Application Publication
(10) Pub. No.: US 2019/0372437 A1
(43) Pub. Date: Dec. 5, 2019

(54) METHOD FOR RESTORING SEPARATION BETWEEN LAMINATIONS OF GENERATOR STATOR CORE

(71) Applicant: Siemens Energy, Inc., Orlando, FL (US)

(72) Inventors: Shane Bell, Chuluota, FL (US); Randy Edward Whitener, Chuluota, FL (US)

(21) Appl. No.: 15/994,218

(22) Filed: May 31, 2018

(51) Int. Cl. H02K 15/00; H02K 11/20; H02K 1/16; H02K 15/10; H02K 15/02

(52) U.S. Cl. CPC H02K 15/0006; H02K 11/20; H02K 15/024; H02K 15/10; H02K 1/16

(57) ABSTRACT

A method for restoring a separation between laminations of a stator core of a generator is presented. The laminations are separated from each other by an insulation layer disposed between the laminations. Wicking resin is applied to an area where the laminations are in contact with each other. Etching using an etching solution is applied to the area where the laminations are in contact with each other until a separation between the laminations is restored. The wicking resin seals the insulation layer to prevent the etching solution from penetrating into the insulation layer and causing a detrimental effect on the insulation layer.

### TECHNICAL FIELD

The present invention relates generally to a method for restoring a separation between laminations of a stator core of a generator.

### DESCRIPTION OF RELATED ART

A generator is a component in power generation industry that converts mechanical power to electrical power. A generator typically includes a stator and a rotor. A generator stator may employ a stator core comprised a plurality of axially extending slots along an internal circumference of the stator core. Stator windings are placed in the slots with insulation from the stator core. A rotor may be installed within the stator core.

A stator core may consist of a plurality of packs of stacked thin metal laminations. The laminations are insulated from each other by a very thin dielectric. The laminations direct magnetic flux around the stator core. If a number of laminations short together such that a loop can be established around the magnetic flux, then current will circulate in that loop generating heat. Shorting of laminations may occur very often due to foreign objects which may damage insulations between the laminations and smear the laminations together or may provide a path by connecting adjacent laminations with a conductive material. Other modes of lamination to lamination shorting may occur due to excessive heat from various sources affecting the dielectric coating. Damaged insulation of stator core may result in higher eddy current and a higher local temperature, also known as a local hot spot, between several laminations. The damage may spread out along the stator core over time and may cause damage of the generator.

To prevent current circulation within the stator core, a clear separation between the laminations needs to be restored. Typically, hand tools are used for restoring a clear separation between the laminations. The hand tools may include a small dental pick or similar to hand pick the attached laminations away and restore the clear separation between laminations. The hand tools tend to smear the laminations across their insulation boundaries. The process is also time consuming. There is a need to provide an easy and simple process for restoring a separation between laminations of a generator stator core.

### SUMMARY OF INVENTION

Briefly described, aspects of the present invention relate to a method for restoring a separation between laminations of a stator core of a generator, a stator core of a generator, and a method for servicing a stator core of a generator.

According to an aspect, a method for restoring a separation between laminations of a stator core of a generator is presented. The method comprises applying a wicking resin to an area where the laminations are in contact with each other. The method comprises applying an etching using an etching solution to the area where the laminations are in contact with each other until a separation between the laminations is restored. The laminations are separated from each other by an insulation layer disposed between the laminations. The wicking resin is configured to seal the insulation layer to prevent the etching solution from penetrating into the insulation layer and causing a detrimental effect on the insulation layer.

According to an aspect, a stator core of a generator is presented. The stator core comprises a plurality of laminations. The stator core comprises an insulation layer disposed between the laminations that is configured to separate the laminations from each other. The insulation layer is configured to be sealable by a wicking resin. The wicking resin is configured to enable applying an etching using an etching solution to an area where the laminations are in contact with each other for restoring a separation between the laminations. The wicking resin is configured to prevent the etching solution from penetrating into the insulation layer and causing a detrimental effect on the insulation layer.

According to an aspect, a method for servicing a stator core of a generator is presented. The stator core comprises a plurality of laminations. The method comprises performing a test to the stator core for detecting an area where the laminations are in contact with each other. The method comprises applying a wicking resin to the area where the laminations are in contact with each other. The method comprises applying an etching using an etching solution to the area where the laminations are in contact with each other until a separation between the laminations is restored. The laminations are separated from each other by an insulation layer disposed between the laminations. The wicking resin is configured to seal the insulation layer to prevent the etching solution from penetrating into the insulation layer and causing a detrimental effect on the insulation layer.

Various aspects and embodiments of the application as described above and hereinafter may not only be used in the combinations explicitly described, but also in other combinations. Modifications will occur to the skilled person upon reading and understanding of the description.

### BRIEF DESCRIPTION OF DRAWINGS

Exemplary embodiments of the application are explained in further detail with respect to the accompanying drawings. In the drawings:

FIG. 1 illustrates a schematic cross section view of a generator in which embodiments of the present invention may be implemented;

FIG. 2 illustrates a schematic cross section view of stacked laminations;

FIG. 3 illustrates a schematic plan view of a lamination;

FIG. 4 illustrates a schematic cross section view of stacked laminations having an area where the laminations are in contact with each other;

FIG. 5 illustrates a schematic cross section view of stacked laminations in which embodiments of the present invention are implemented; and

FIG. 6 illustrates a schematic process flow chart for servicing a stator core of a generator according to an embodiment of the present invention.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

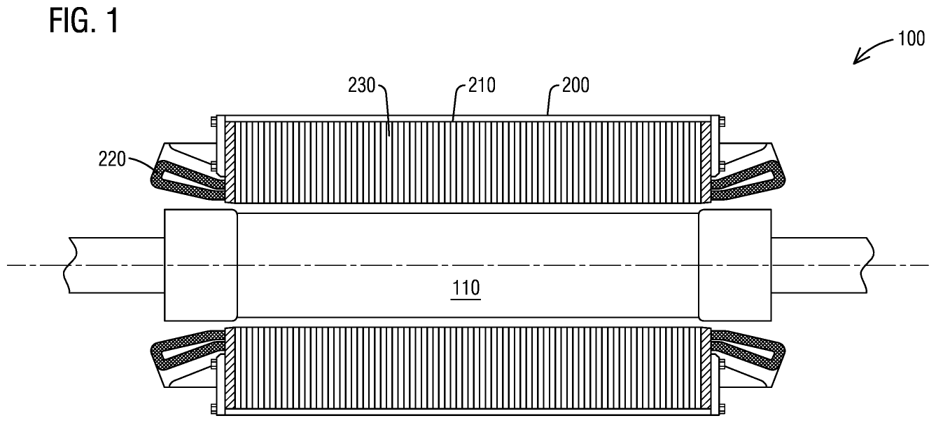

FIG. 1 illustrates a schematic cross section view of a generator 100. The generator 100 includes a rotor 110 and a stator 200. The stator 200 has a stator core 210. The rotor 110 is installed within the stator core 210. A stator winding 220 may be arranged within the stator core 210. The stator core 210 may be comprised of a plurality of stacked thin metal laminations 230.

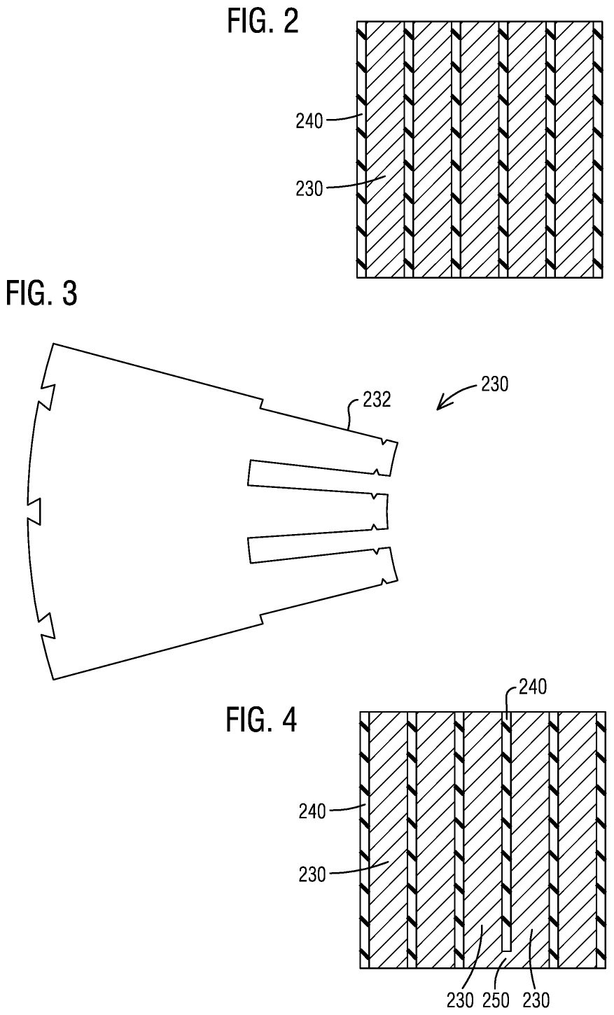

FIG. 2 illustrates a schematic cross section view of stacked laminations 230. As shown in FIG. 2, the laminations 230 are separated from each other by an insulation layer 240. The insulation layer 240 may include any suitable materials, such as non-porous material, porous material, insulation paper, fiber glass, etc. The insulation layer 240 is much thinner than the lamination 230. For example, the lamination 230 may have a thickness in an order of millimeters. The insulation layer 240 may have a thickness in an order of micrometers.

During generator operation, a portion of the insulation layer 240 may be damaged. A portion of the laminations 230 along the portion of the damaged insulation layer 240 may be in contact with each other which may result in circulating current within the stator core 210. The circulating current may damage the stator core 210 and the generator 100. A clear separation between the laminations 230 are required in the stator core 210 of the generator 100 for preventing the damage of the stator core 210 and the generator 100.

FIG. 3 illustrates a schematic plan view of a lamination 230. As shown in FIG. 3, an inner portion of the lamination 230 has a tooth shape comprised of a plurality of tooth 232. Typically, damage of the insulations layer 240 occurs near the tooth 232 of the lamination 230. As such, the laminations 230 at a region of the tooth 232 may be in contact with each other across a boundary of the insulation layer 240. The laminations 230 at other regions may be separated from each other by non-damaged insulation layer 240.

FIG. 4 illustrates a schematic cross section view of stacked laminations 230 having an area 250 where the laminations 230 are in contact with each other. As shown in FIG. 4, the insulation layer 240 at the area 250 is damaged. The laminations 230 at the area 250 are thus in contact with each other. The area 250 may be a region near the tooth 232 of the lamination 230. The laminations 230 at other regions are separated from each other by non-damaged insulation layer 240.

Etching is a process using an etching solution to cut into metal surface. The etching solution may include a strong acid. Etching is an effective and efficient process to restore a clear separation between the laminations 230. However, the etching solution may cause detrimental effects on the non-damaged insulation layers 240. For example, for insulation layers 240 using non-porous materials, the etching may achieve a clear separation between laminations 230 without detrimental effects on the non-damaged insulation layer 240. For insulation layers 240 using porous materials or insulation paper, the etching solution may soak into the non-damaged insulation layers 240 and thus cause detrimental effects on the non-damaged insulation layers 240.

To use etching to restore a clear separation between the laminations 230 without causing detrimental effects on the non-damaged insulation layers 240, a wicking resin may be applied to the area 250 where the laminations 230 are in contact with each other. The wicking resin penetrates the non-damaged insulation layer 240 between the laminations 230. The wicking resin thus seals the non-damaged insulation layer 240 between the laminations 230 and provides a coating to the non-damaged insulation layer 240. For insulation layer 240 using porous materials or insulation paper, the wicking resin soaks into the non-damaged insulation layer 240 and provides a coating to the non-damaged insulation layer 240. For insulation layer 240 using non-porous materials, the wicking resin enhances the non-damaged insulation layer 240 and provides a coating to the non-damaged insulation layer 240. The wicking resin may be applied by any suitable manners, such as by spray, or by brush, etc. The wicking resin may include any suitable wicking resins that may seal the non-damaged insulation layer 240 and prevent an etching solution from penetrating and causing detrimental effects on the non-damaged insulation layer 240 when using etching to restore a separation between the laminatiopns 230.

Etching using an etching solution may be applied to the area 250 where the laminations are in contact with each other after applying the wicking resin. The etching solution may cut away the area 250 where the laminations 230 are in contact with each other. The non-damaged insulation layer 240 is sealed by the wicking resin to prevent the etching solution from penetrating and causing detrimental effects on the non-damaged insulation layer 240. The etching may be applied by any suitable manners, such as by spray, or by brush, etc. The etching solution may include any suitable etching solutions that may be used by the etching to cut away the area 250 where the laminations 230 are in contact with each other. The etching is applied until a separation between the laminations 230 by the non-damaged insulation layer 240 is restored.

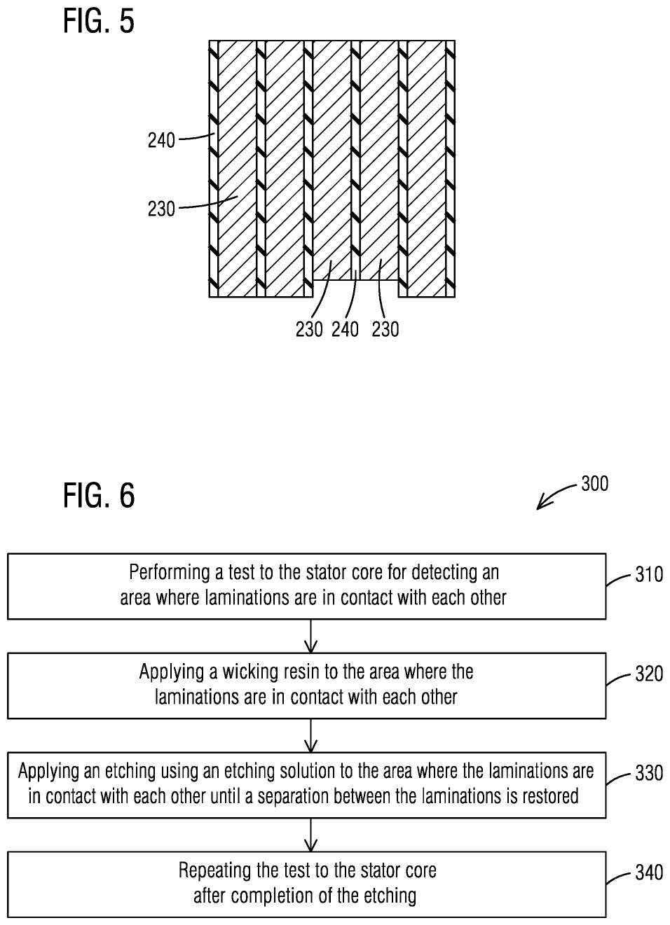

FIG. 5 illustrates a schematic cross section view of stacked laminations 230 where the separation between the laminations 230 by the non-damaged insulation layer 240 is restored after applying the wicking resin and the etching. As shown in FIG. 5, the area 250 where the laminations 230 are in contact with each other is cut away by the etching solution. The laminations 230 are separated from each other by the non-damaged insulation layer 240 that is sealed by the wicking resin for prevent an etching solution from penetrating and causing detrimental effects on the non-damaged insulation layer 240.

FIG. 6 is a schematic process flow chart 300 for servicing a stator core 210 of a generator 100 according to an embodiment of the present invention. In step 310, a test may be performed to the stator core 210 for detecting an area 250 where laminations 230 are in contact with each other. The insulation layer 240 in the area 250 may be damaged due to various reasons. The test may include any suitable tests known in the industry, such as a loop test. In step 320, a wicking resin is applied to the area 250 where the laminations 230 are in contact with each other. The wicking resin seals the non-damaged insulation layer 240 between the laminations 230 and provides a coating to the non-damaged insulation layer 240. In step 330, an etching using an etching solution is applied to the area 250 where the laminations 230 are in contact with each other. The etching solution used by the etching may cut away the area 250 where the laminations 230 are in contact with each other. The etching is applied until a separation between the laminations 230 by the non-damaged insulation layer 240 is restored. In step 340, the test may be repeated to the stator core 210 after completion of the etching to ensure the laminations 230 are properly separated.

According to an aspect, the proposed method provides an easy process for restoring a separation between laminations 230 of a stator core 210 of a generator 100. The proposed method uses wicking resin to protect the insulation layer 240 disposed between the laminations 230. The insulation layer 240 may include any suitable materials, such as porous materials, non-porous materilas, or insulation paper. The wicking resin seals the insulation layer 240 and provides a coating to the insulatin layer 240. The coating of the insulation layer 240 prevents an etching solution from penetrating and causing detrimental effects on the insulation layer 240 when using the etching to restore a separation between the laminatiopns 230 of a stator core 210 of a generator 100. The proposed method provides significantly cost savings and significantly increase efficiency for maintenance of a generator 100. The proposed method significantly increases operation life of a generator 100.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### REFERENCE LIST

100: Generator
110: Rotor
200: Stator
210: Stator Core
220: Stator Winding
230: Lamination
232: Lamination Tooth
240: Insulation Layer
250: Area where laminations are in contact with each other
300: Process Flow Chart

What is claimed is:

1. A method for restoring a separation between laminations of a stator core of a generator comprising:
applying a wicking resin to an area where the laminations are in contact with each other; and
applying an etching using an etching solution to the area where the laminations are in contact with each other until a separation between the laminations is restored,
wherein the laminations are separated from each other by an insulation layer disposed between the laminations, and
wherein the wicking resin is configured to seal the insulation layer to prevent the etching solution from penetrating into the insulation layer and causing a detrimental effect on the insulation layer.

2. The method as claimed in claim 1, wherein the insulation layer comprises a porous material.

3. The method as claimed in claim 1, wherein the insulation layer comprises an insulation paper.

4. The method as claimed in claim 1, wherein the wicking resin is applied by spray.

5. The method as claimed in claim 1, wherein the wicking resin is applied by brush.

6. The method as claimed in claim 1, wherein the etching is applied by spray.

7. The method as claimed in claim 1, wherein the etching is applied by brush.

8. The method as claimed in claim 1, wherein the etching solution cuts away the area where the laminations are in contact with each other.

9. The method as claimed in claim 1, further comprising performing a test to the stator core for detecting the area where the laminations are in contact with each other prior to applying the wicking resin.

10. The method as claimed in claim 1, further comprising performing a test to the stator core after completion of the etching.

11. A stator core of a generator comprising:
a plurality of laminations; and
an insulation layer disposed between the laminations that is configured to separate the laminations from each other,
wherein the insulation layer is configured to be sealable by a wicking resin,
wherein the wicking resin is configured to enable applying an etching using an etching solution to an area where the laminations are in contact with each other for restoring a separation between the laminations, and
wherein the wicking resin is configured to prevent the etching solution from penetrating into the insulation layer and causing a detrimental effect on the insulation layer.

12. The stator core as claimed in claim 11, wherein the insulation layer comprises a porous material.

13. The stator core as claimed in claim 11, wherein the insulation layer comprises an insulation paper.

14. The stator core as claimed in claim 11, wherein the etching solution cuts away the area where the laminations are in contact with each other.

15. A method for servicing a stator core of a generator, wherein the stator core comprises a plurality of laminations, the method comprising:
performing a test to the stator core for detecting an area where the laminations are in contact with each other;
applying a wicking resin to the area where the laminations are in contact with each other; and
applying an etching using an etching solution to the area where the laminations are in contact with each other until a separation between the laminations is restored,
wherein the laminations are separated from each other by an insulation layer disposed between the laminations, and
wherein the wicking resin is configured to seal the insulation layer to prevent the etching solution from penetrating into the insulation layer and causing a detrimental effect on the insulation layer.

16. The method as claimed in claim 15, wherein the insulation layer comprises a porous material.

17. The method as claimed in claim 15, wherein the insulation layer comprises an insulation paper.

18. The method as claimed in claim 15, wherein the etching solution cuts away the area where the laminations are in contact with each other.

19. The method as claimed in claim 15, further comprising repeating the test to the stator core after completion of the etching.

20. The method as claimed in claim 15, wherein the test comprises a loop test.
